(19) United States
(12) Patent Application Publication
(10) Pub. No.: US 2023/0055980 A1
(43) Pub. Date: Feb. 23, 2023

(54) SYSTEMS AND METHODS FOR INDUCTIVE ANOMALY DETECTION FOR ATTRIBUTED NETWORKS

(71) Applicants: Kaize Ding, Tempe, AZ (US); Huan Liu, Tempe, AZ (US)

(72) Inventors: Kaize Ding, Tempe, AZ (US); Huan Liu, Tempe, AZ (US)

(73) Assignee: Arizona Board of Regents on Behalf of Arizona State University, Tempe, AZ (US)

(21) Appl. No.: 17/742,236

(22) Filed: May 11, 2022

Related U.S. Application Data
(60) Provisional application No. 63/187,032, filed on May 11, 2021.

(51) Int. Cl. G06N 3/04; G06N 3/08

(52) U.S. Cl. CPC G06N 3/0454; G06N 3/088

(57) ABSTRACT

Various embodiments of systems and methods for inductive anomaly detection on attributed networks using a graph neural layer to learn anomaly-aware node representations and further employ generative adversarial learning to detect anomalies among new data are disclosed herein.

### CROSS-REFERENCE TO RELATED APPLICATIONS

This is a non-provisional application that claims benefit to U.S. Provisional Patent Application Ser. No. 63/187,032 filed 11 May 2021, which is herein incorporated by reference in its entirety.

### GOVERNMENT SUPPORT

This invention was made with government support under 1614576 awarded by the National Science Foundation and N00014-16-1-2257 awarded by the Office of Naval Research. The government has certain rights in the invention.

### FIELD

The present disclosure generally relates systems and methods for inductive anomaly detection for attributed networks, and in particular to inductive anomaly detection on attributed networks using a graph neural layer to learn anomaly-aware node representations and further employ generative adversarial learning to detect anomalies among new data.

### BACKGROUND

In a variety of real-world applications (e.g., social spam detection, financial fraud detection, and network intrusion detection), detecting anomalies from networked data plays a vital role in keeping malicious behaviors or attacks at bay. With the increasing usage of attributed networks for modeling various information systems, anomaly detection on attributed networks has become a fundamental learning task, which aims to accurately characterize and detect anomalies (i.e., abnormal nodes) whose patterns (w.r.t., structure and attributes) deviate significantly from the majority reference nodes.

As it is costly and labor-intensive to obtain the label information of anomalies, anomaly detection on attributed networks is predominately carried out in an unsupervised manner. Due to the fact that real-world attributed networks are rapidly growing, the problem of anomaly detection on attributed networks can be further divided into two settings based on the way how new data is handled: (1) transductive setting and (2) inductive setting. The former performs anomaly detection on a single, fixed attributed network that includes new nodes and the latter anticipates to handle newly observed nodes or (sub)networks with a previously learned model. Though extensive research has been conducted on the first setting and achieved immense success, inductive anomaly detection on attributed networks has heretofore received little attention. Restricted by their upfront access to global network structure (e.g., methods based on matrix factorization and spectral convolution), transductive anomaly detection methods need to retrain the model when new data arrives, which tends to be computationally expensive.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIGS. 1A-1D are a series of simplified diagrams illustrating aspects of a network anomaly evaluation system; FIG. 1A is an illustration showing a graph differentiative layer of the network anomaly evaluation system; FIG. 1B is an illustration showing the network anomaly evaluation system; FIG. 1C is an illustration showing the network anomaly evaluation system of FIG. 1B during a training phase; and FIG. 1D is an illustration showing the network anomaly evaluation system of FIG. 1B when evaluating a new network.

FIG. 2A is an illustration showing the learning mechanism behind Ano-GAN before training in which the Ano-GAN cannot generate informative anomalies at its early learning stage and FIG. 2B is an illustration showing the learning mechanism behind Ano-GAN after training in which the Ano-GAN is able to generate anomalies that generally lie close to normal data.

FIGS. 3A-3C are graphical representations showing inductive anomaly detection results on three different datasets with respect to ROC curve and AUC value.

FIGS. 4A-4C are graphical representations showing transductive anomaly detection results on three different datasets with respect to ROC curve and AUC value.

FIG. 5A is a graphical representation showing the effect of node-level attention; and FIG. 5B is a graphical representation showing the effect of parameter k in neighborhood-level attention.

FIGS. 6A and 6B are a series of process flows showing a method for network anomaly evaluation by the system of FIGS. 1A-1D.

FIG. 7 is a simplified illustration showing an exemplary computer system for effectuating the functionalities of the system of FIGS. 1A-1D.

Corresponding reference characters indicate corresponding elements among the view of the drawings. The headings used in the figures do not limit the scope of the claims.

### DETAILED DESCRIPTION

Given its capability of learning representations on newly observed nodes without retraining the whole model from scratch, graph neural networks have drawn great interest from researchers lately. Instead of training a distinct embedding vector for each node, those methods learn a set of aggregator functions to aggregate features from a node's local neighborhood. Inspired by their success, the present disclosure approaches the studied problem by virtue of inductive representation learning. However, building a principled inductive anomaly detection model for attributed networks remains a daunting task due to the following two challenges: (1) Existing graph neural networks are ineffective to characterize node abnormality since they are not tailored for anomaly detection problems. On the one hand, as malicious users might build spurious connections with normal nodes to camouflage their noxious intentions, directly aggregating features from neighboring nodes may cause learned representations of truly anomalous nodes to be inexpressive for anomaly detection. On the other hand, due to the fact that network structures of many real-world attributed networks are highly sparse, solely relying on the context information aggregated from the local neighborhood can be less informative and noisy. The above issues necessitate a new design of graph neural network, which allows the model to learn anomaly-aware node representations from arbitrary-order neighbors. (2) Unseen anomalies that emerge in newly added data could incur infeasibility of previously learned detection models. For an inductive anomaly detection model, its training network is only partially observed. Though normal data tends to be stable, anomalies in observed and unseen data could be from very different manifolds. Thus, a previously learned anomaly detection model might lose its discriminability on newly observed nodes. As such, a system outlined in the present disclosure seeks to solve the problem of how to improve the generalization ability of inductive models for detecting those unseen anomalies.

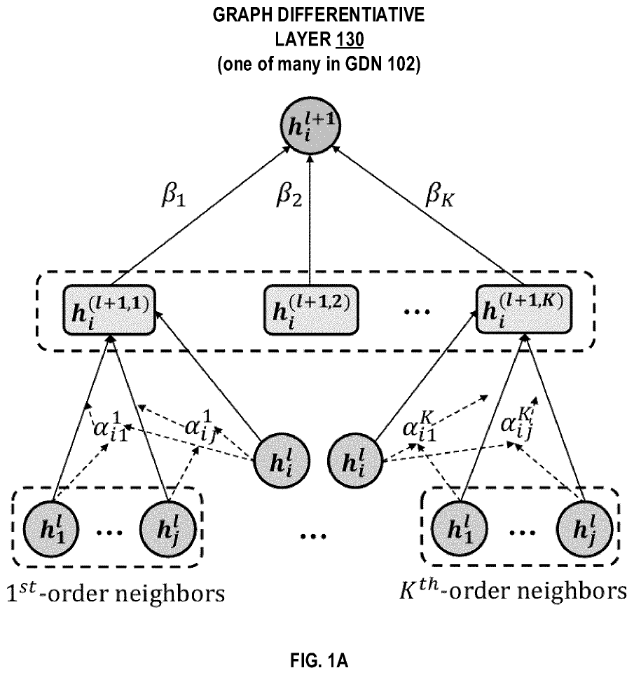

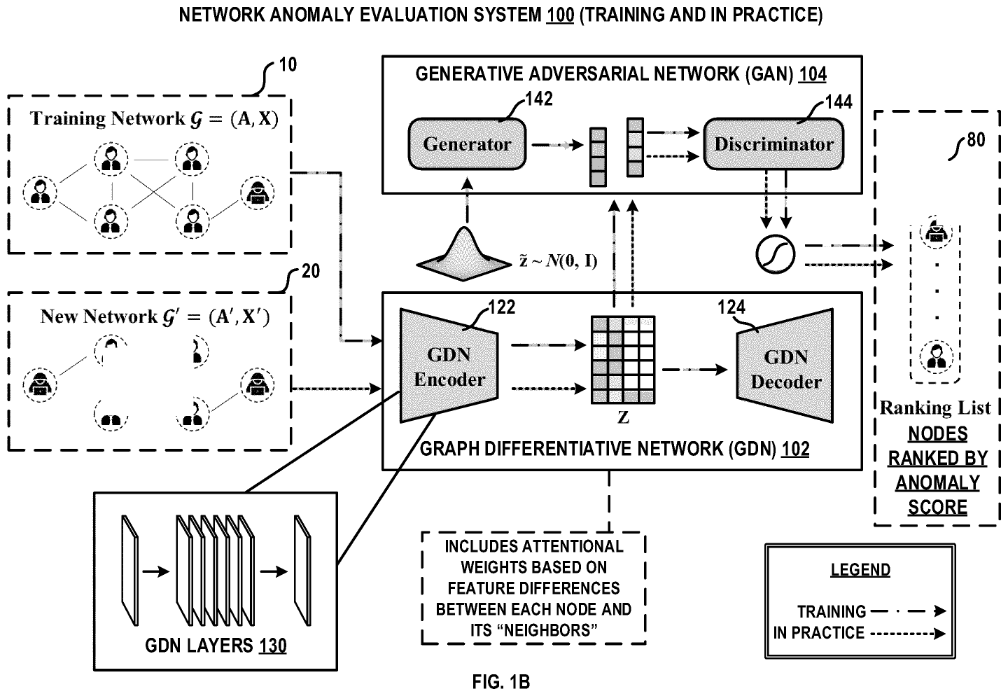

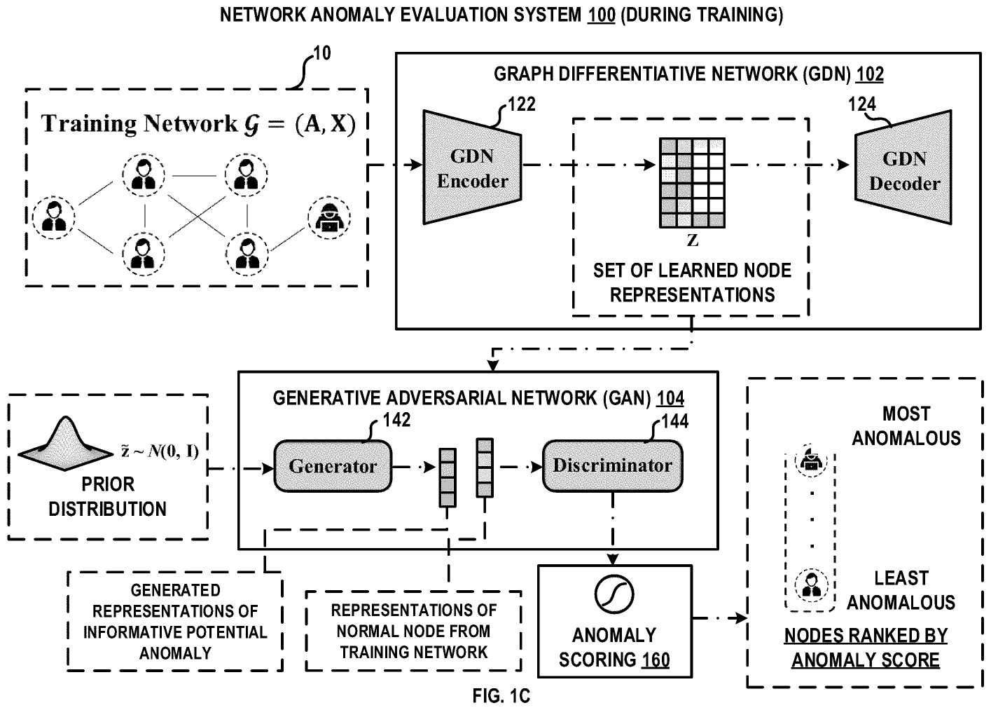

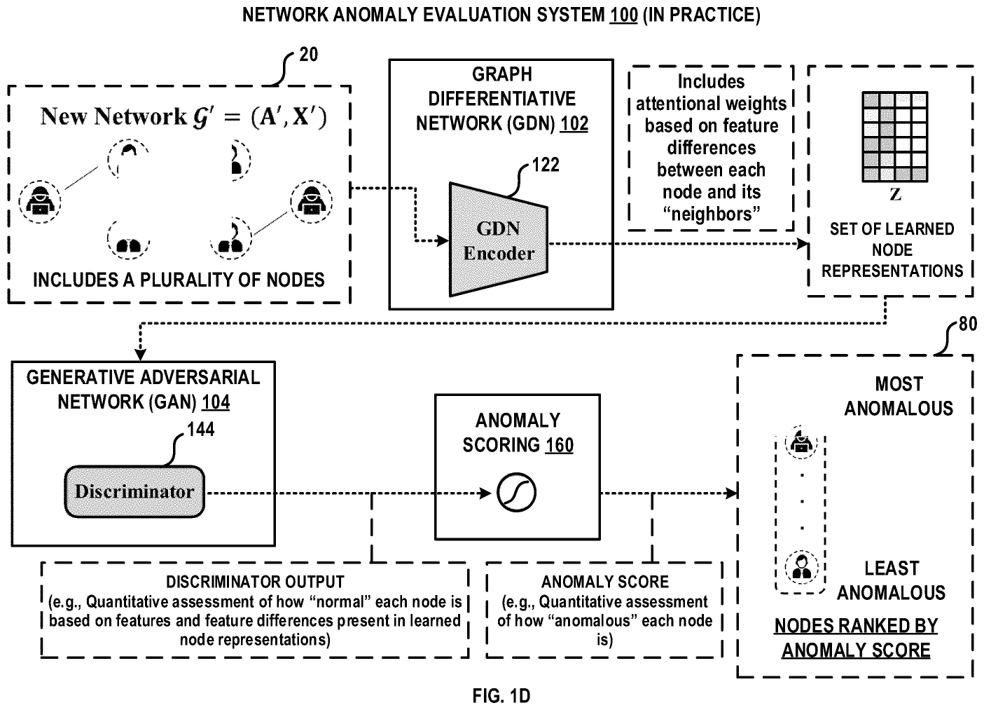

To address the challenges above, and with reference to FIGS. 1A-1D, a network anomaly evaluation system 100 (also referred to as adversarial graph differentiation autoencoders, or “AEGIS”; hereinafter, “system” 100) is disclosed herein for inductive anomaly detection on attributed networks. Built upon a plurality of graph differentiative layers 130 described in further detail herein, the system 100 first learns a set of learned node representations of a network that are anomaly-aware through a graph differentiative network 102 (hereinafter, GDN 102) that includes an encoder network 122 (autoencoder network GDN-AE). The GDN 102 includes attentional weights that capture feature differences between each respective node in the network and those of its “neighboring” nodes. The system 100 further includes a generative adversarial network 104 (hereinafter, “GAN” 104, also referred to as Ano-GAN) to improve model generalization ability for newly added data which provides a quantitative assessment of how “normal” each node is based on the features and feature differences present in the set of learned node representations. Specifically, the GAN 104 includes a generator network 142 that aims to generate informative potential anomalies, while a discriminator network 144 tries to learn a decision boundary that separates the informative potential anomalies from normal data so as to quantify how anomalous each node in the network is. As such, the system 100 eliminates the restriction of transductive models and acquires strong capability in detecting anomalies among newly added nodes. In summary, the main contributions of the system 100 are:

The system 100 is the first to address the problem of inductive anomaly detection on attributed networks, which specifically addresses the limitation of existing anomaly detection methods.

In addition, the system 100 includes the graph differentiative layers 130 that perform anomaly detection in both inductive and transductive settings.

### Problem Formulation

Throughout the present disclosure, calligraphic fonts, bold lowercase letters, and bold uppercase letters will be used to denote sets (e.g., V), vectors (e.g., x), and matrices (e.g., X), respectively. Generally, with reference to FIGS. 1B-1D, an attributed network such as training network 10 can be represented by a graph [symbol] =(A, X), where A denotes the adjacency matrix and X denotes the attribute matrix. A similar attributed network that the system 100 can take as input and perform an anomaly evaluation task, such as new network 20 can be represented by a graph [symbol] =(A′, X′), where A′ denotes the adjacency matrix of the new network 20 and X′ denotes the attribute matrix of the new network. The task of anomaly detection on attributed networks can be classified into the transductive setting and inductive setting. To make the results more interpretable, they are formulated as two ranking problems:

Problem 1 Inductive Anomaly Detection on Attributed Networks: Given a graph indicative of a partially observed attributed network [symbol] =(A, X) for training and a graph indicative of a newly observed (sub)network [symbol] =(A′, X′) for testing, the task is to rank all the nodes in [symbol] according to the degree of abnormality, such that abnormal nodes should be ranked on higher positions.

It is worth mentioning that, although the aim is to apply inductive anomaly detection, the system 100 is operable to handle transductive anomaly detection as well.

### System Framework

In this section, various building block layers used to construct the system 100 will be discussed with reference to FIGS. 1A-1D. The architecture of the system 100 and its learning process for inductive anomaly detection on attributed networks are further described herein.

### Graph Differentiative Layer

In one aspect, the system 100 includes a graph differentiation network (GDN) 102 that includes the plurality of graph differentiative layers 130 (“GDN layers” 130) for performing inductive anomaly detection on new data. FIGS. 1A and 1B in particular illustrate a graph differentiative layer 130 (“GDN layer” 130) of the plurality of GDN layers 130 that takes an input representation of a node in a network such as training network 10 or new network 20 and generates a set of learned representations of the node while observing various feature differences between the node and other neighboring nodes, enabling the system 100 to quantify how “anomalous” the node is. Apart from existing GNNs, the GDN 102 is capable of learning anomaly-aware node representations from arbitrary-order neighborhoods. Specifically, the GDN layer 130 has an attention-based hierarchical structure described as follows:

Node-level Attention. According to the principle of homophily, instances with similar patterns are more likely to be linked together in attributed networks, and measuring of homophily can be an effective way to detect anomalies. Thus for each node, the system 100 includes an attention mechanism to capture the feature difference between the node and its neighbors. In this way, the system 100 enables the learned representation to differentiate a node from its neighbors if its features deviate significantly from those of its neighbors. Specifically, for any GDN layer 130 I of the plurality of GDN layers 130 in GDN 102, each GDN layer 130 generates a learned node representation of node i by:

hᵢ^{(l)}=σ(W₁hᵢ^{(l-1)}+ [symbol] αᵢⱼW₂Δ_{i,j}^{(l-1)}), (1)

where h^{(l-1)}∈ [symbol] ^{F}, h^{(l)}∈ [symbol] ^{F} denote the input and output representation of node i, respectively. Δ_{i,j}^{(l-1)}=hᵢ^{(l-1)}−hⱼ^{(l-1)} is indicative of a feature difference between node i and j. W₁, W₂∈ [symbol] ^{F×F} are two trainable weight matrices and σ is a nonlinear activation function. [symbol] denotes the neighboring nodes of node i. Here αᵢⱼ is the attention coefficient between node i and node j, which can be expressed as:

$${α}_{i j} = \frac{exp ( σ ( {a}^{T} {W}_{2} {Δ}_{i , j}^{( l - 1 )} ) )}{{\sum }_{k ∈ {𝒩}_{i}} exp ( σ ( {a}^{T} {W}_{2} {Δ}_{i , k}^{( l - 1 )} ) )} , \qquad ( 2 )$$

Where a∈ [symbol] ^{F} is the attention vector that assigns importance to different neighbors of node i. Apart from other methods employing graph attention networks, the system 100 generates attentional weights based on feature differences between nodes rather than based on concatenation of two neighboring features, enabling the system 100 to explicitly measure network homophily and characterize the abnormality of each node.

Similarly, by extracting k^{th}-order neighbors of node i from

$${A}^{k} = {\underbrace{A \cdot A … A}}_{k} ,$$

the system 100 computes its k^{th}-order node representation hᵢ^{(i,k)}. As different “neighborhoods” encode different contact information, the system 100 can use neighborhood-specific representations for addressing sparsity issues and learning a more powerful anomaly detector.

Neighborhood-level Attention. The system 100 aggregates K neighborhood-specific representations to a unified representation. As neighbors from different distances contribute differently to characterize a node, the system 100 applies location-based attention on those neighborhood-specific representations in order to capture the significance of different neighborhoods. Formally, each GDN layer 130 I integrates a final learned representation of the node i by:

hᵢ^{(l)}=Σₖ₌₁^{K}βᵢ^{k}hᵢ^{(l,k)}, (3)

where βᵢ^{k} denotes the attention coefficient on k^{th}-order representation hᵢ^{(l,k)} which can be formulated as:

$${β}_{i}^{k} = \frac{exp ( σ ( {\hat{a}}^{T} {h}_{i}^{( l , k )} ) )}{{\sum }_{{k}^{′} = 1}^{K} exp ( σ ( {\hat{a}}^{T} {h}_{i}^{( l , k ′ )} )} , \qquad ( 4 )$$

Note that â∈ [symbol] ^{F} is the attention vector that allows the system 100 to specify different significance to different intermediate representations for learning the unified representation of each node. In this way, each GDN layer 130 is operable to aggregate expressive context information for characterizing node abnormality from neighbors with various numbers of hops away. By applying this process to each node in the network, the GDN 102 enables the system 100 to generate a set of learned node representations for the network that captures feature differences between each respective node in the network and those of its “neighboring” nodes, which further enables the system 100 to quantify how “anomalous” each node in the network is.

### Adversarial Graph Differentiation Network

In one aspect, the system 100 also implements the GAN 104 to improve robustness by generating informative potential anomalies. In particular, during training of the system 100, the generator network 142 of the GAN 104 generates informative potential anomalies to help improve the performance of the discriminator network 144 that quantifies how “normal” each node in the network is based on the set of learned node representations provided by the GDN 102. Following training of the system 100, the discriminator network 144 can quantify how “normal” each node in the network is based on the set of learned node representations without additional input from the generator network 142.

### Dual-Phase Anomaly Quantification

As depicted in FIGS. 1B-D, the system 100 includes two “phases” for quantifying how anomalous each node in a network is. The first phase uses the GDN 102 and aims to learn models to generate the set of learned node representations from a graph indicative of an input network (such as new network 20) through the encoder network 122 (autoecoder network GDN-AE) of the GDN 102, which is built with the plurality of GDN layers 130. Specifically, the encoder network 122 Enc compresses the graph to low-dimensional node representations Z, and a decoder network 124 Dec learns models to reconstruct the input data afterwards to train the encoder network 122. The encoder network 122 of the GDN 102 learns how to model anomaly-aware node representations, and is expected to map the normal and abnormal nodes to different regions in the latent feature space.

With the learned anomaly-aware node representations, the second phase aims to train the GAN 104 (Ano-GAN) that can accurately model the distribution of normal data. Specifically, the generator network 142 G takes noises sampled from a prior distribution p(\tilde{z}) as input, and attempts to generate “convincing” informative potential anomalies that resemble normal nodes. Meanwhile, the discriminator network 144 D tries to distinguish whether a representation is the representation of a normal node or a generated anomaly from the generator network 142 G, iteratively improving its ability to distinguish normal nodes from anomalous nodes. The GAN 104 can implement a minmax function as follows:

$${min}_{G} {max}_{D} {𝔼}_{z ∼ Z} [ log D ( z ) ] + {𝔼}_{\tilde{z} ∼ p ( \tilde{z} )} [ log ( 1 - D ( G ( \tilde{z} ) ) ) ] , \qquad ( 5 )$$

where p(\tilde{z}) is the prior distribution. Preliminary experiments show that Gaussian prior is a robust option for different datasets.

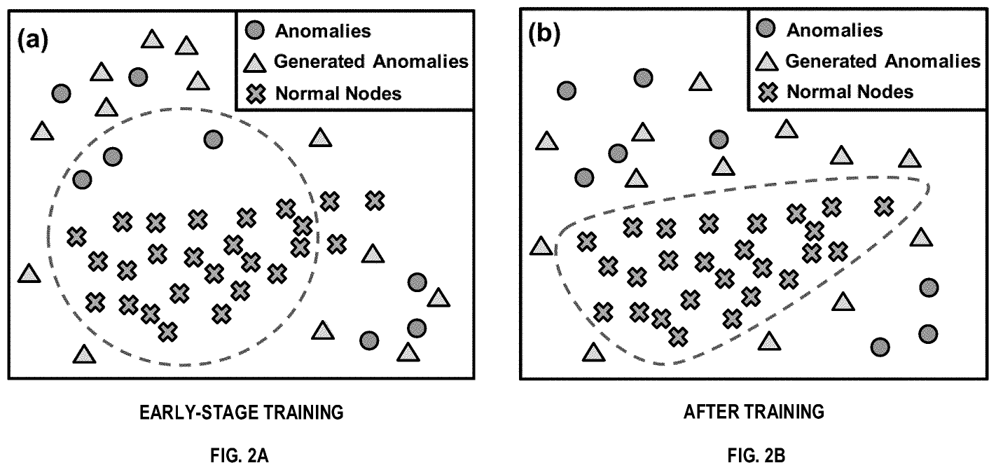

During the training or learning process as the minmax function in Eq. 5 converges, the generator network 142 G gradually learns the generating mechanism and synthesizes an increasing number of potential anomalies that may arise in the unseen data. As reflected in FIGS. 2A and 2B, the discriminator network 144 D accurately learns a distribution of normal nodes present within real data and determines a decision boundary that encloses concentrated normal nodes. Ideally, for generated anomalies to be “informative” about the distribution of normal data, the generated anomalies need to be concentrated generally close to the normal data. In one example corresponding to a network security context, an anomalous node can represent a malicious user who might be able to camouflage as a normal node by building connections with normal nodes and by exhibiting certain features. As such, a set of features of the anomalous node might lie “deceptively” close to those of normal nodes and may have connections with normal nodes.

FIG. 2A is an example plot showing an example distribution of nodes as observed or generated by of the GAN 104 with a decision boundary at an early training stage, and FIG. 2B is an example plot showing an example distribution of nodes with a decision boundary after training. In the plot of FIG. 2A the inputs to the GAN 104 are a training set of learned node representations that describe features of a plurality of training nodes which include normal nodes (“X” shape) and anomalous nodes (circle shape) and are each plotted in FIG. 2A according to their features. It is expected that normal nodes would be located within a similar region to one another on the plot. In this example, the generator network 142 is mostly untrained, and generates a plurality of anomalies (triangle shape) that are plotted in FIG. 2A on the same distribution as the real nodes. Note that the generated anomalies in FIG. 2A are scattered throughout the plot and as a result they are not particularly “informative” as to what the distribution of normal data should look like. Also note that in this example, the discriminator network 144 is also mostly untrained and determines a decision boundary where it expects the “normal” nodes to be concentrated, however the decision boundary is shown to leave out several “normal” nodes and includes several anomalous nodes while not accurately depicting the “shape” of how the normal nodes are concentrated.

In contrast, FIG. 2B is an example plot illustrating the same distribution of real data from the training graph that includes anomalous nodes and normal nodes following training of the GAN 104, which includes new generated anomalies (triangle shape) generated by the generator network 142 and a new decision boundary determined by the discriminator network 144. Note that the new generated anomalies are more evenly distributed among the actual anomalous nodes from the training graph and are concentrated closer to the distribution of normal nodes, reflecting that the generator network 142 iteratively attempts to model what an anomalous node that resembles normal nodes within a real data distribution should look like and gets better at this task as the minmax function in Eq. (5) converges during training. Similarly, as the minmax function in Eq. (5) converges during training, the discriminator network 144 iteratively determines the new decision boundary that appears to better reflect the actual “shape” of the distribution of normal nodes, and also accurately distinguishes the normal nodes from the generated anomalies that the generator network 142 fabricated to resemble normal nodes.

As such, the generator network 142 G effectively improves the capability of the discriminator network 144 D to identify normal data by generating informative potential anomalies for the discriminator network 144 to distinguish from.

### Learning Process

With reference to FIGS. 1B and 1C, order to train the system 100 to learn models based on newly observed data, different components of the system 100 can be jointly trained in two phases using a training graph representative of a training network such as training network 10, and each phase requires dedicated training objective functions. Specifically, a reconstruction loss of the GDN 102 can be formulated as:

$${ℒ}_{A E} = \frac{1}{n} {\sum }_{i = 1}^{n} {‖ Dec ( En c ( {x}_{i} ) ) - {x}_{i} ‖}^{2} . \qquad ( 6 )$$

Algorithm 1: The training process of AEGIS

| | Input: Attributed network [symbol] = (A, X), Training epochs |
|---|---|
| | Epoch_{AE}, and Epoch_{GAN} |
| | Output: Well-trained GDN-AE and Ano-GAN |
| 1 | i ← 0; |
| 2 | while i <Epoch_{AE} do |
| 3 | Compute the reconstructed node attributes; |
| 4 | Update GDN-AE with the loss function Eq. 6 |
| 5 | i ← 0; |
| 6 | while i < Epoch_{GAN} do |
| 7 | Sample P instances from the node representations Z; |
| 8 | Generate P instances from the prior distribution p(\tilde{z}); |
| 9 | Update the generator G with loss function Eq. (7); |
| 10 | Update the discriminator D with loss function Eq. (8); |
| 11 | return |

A loss function of the GAN 104 (Ano-GAN) can be represented by the conventional cross-entropy loss for training a binary classifier and/or by the minmax function in Eq. 5. In practice, the generator network 142 and the discriminator network 144 of the GAN 104 (Ano-GAN) can be trained separately. For the generator network 142 G, a first loss can be defined as:

[symbol]

_{G}= [symbol] _{\tilde{z}˜p(\tilde{z})}[log(1−D(G(\tilde{z})))], (7)

and a second loss of the discriminator network 144 D is:

[symbol]

_{D}=− [symbol] _{z˜Z}[log D(z)]− [symbol] _{\tilde{z}˜p(\tilde{z})}[log(1−D(G(\tilde{z})))]. (8)

Where the losses in Eqs. 7 and 8 essentially apply the minmax function of Eq. 5. The training process is illustrated in Algorithm 1. After the system 100 converges on the training network 10, the discriminator network 144 D has learned a distribution of normal nodes, and can be directly used to detect anomalies on any newly observed nodes or (sub)networks such as new network 20 shown in FIG. 1D.

### Inductive Anomaly Detection on Newly Observed Networks

The objective of the system 100 is to solve the problem of inductive anomaly detection on attributed networks. Here, the present disclosure elaborates on how to utilize the system 100 having been previously trained to perform anomaly detection on newly observed (sub)networks such as new network 20 shown in FIGS. 1B and 1D. Note that after the training phase shown in FIG. 1C, the system 100 is capable of handling newly added data without retraining the model. With continued reference to FIGS. 1B and 1D, to compute anomaly scores of new (unseen) nodes of the new network 20, the system 100 can retain the parameters from training and directly receive the new (sub)network [symbol] =(A′,X′) (e.g., new network 20) for anomaly evaluation. The system 100 learns a layer-wise set of learned node representations that describe features and feature differences between each node and its “neighbors” of the new network 20 in a feed-forward way through the encoder network 122 of the GDN 102. Then, the system 100 applies the discriminator network 144 of the GAN 104 to evaluate a relative normalcy of each node and provide a quantitative assessment of how “normal” each node is based on features and feature differences present in the set of learned node representations. Upon evaluation of each node by the discriminator network 144, the system 100 then applies an anomaly scoring function 160 on the output of the discriminator network 144 to compute an anomaly score of node i:

score(xᵢ′)=p(yᵢ′=0|zᵢ′)=1−D(zᵢ′). (9)

In practice, the output of the anomaly scoring function 160 is a listing 80 of ranked nodes of the new network 20, where nodes are ranked by anomaly score.

### Experiments

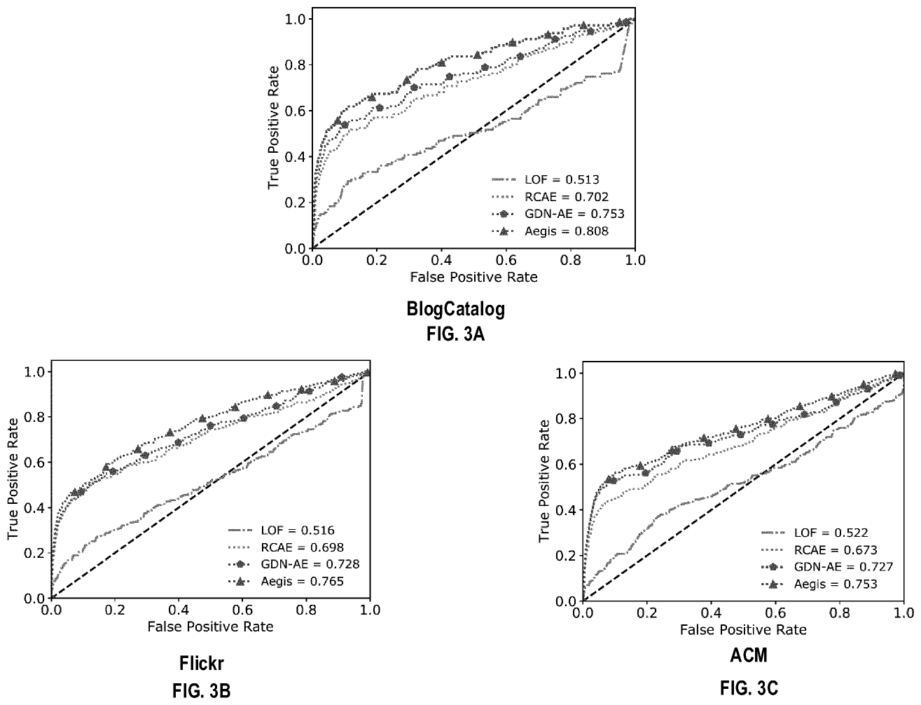

In this section, with reference to FIGS. 3A-5B, evaluations on various real-world datasets were performed to verify the effectiveness of the system 100 (AEGIS) in both inductive and transductive settings.

### Experiment Setup

Compared Methods. In the experiments, the system 100 (AEGIS) was compared with different baseline methods. Specifically, LOF detects anomalies at the contextual level by considering attributes and ConOut detects anomalies by determining its subgraph and its relevant subset of attributes. RCAE and GCN-AE are two autoencoder-based methods for detecting anomalies on i.i.d. data and attributed networks, respectively. Additionally, the encoder network 122 (listed in tables as GDN-AE) of the GDN 102 is included in the system 100 (AEGIS) as another baseline. To summarize, LOF, RCAE and encoder network 122 (GDN-AE) of GDN 102 are inductive models that support both transductive and inductive settings, while ConOut and GCN-AE are two state-of-the-art transductive methods.

Evaluation Datasets. In the experiments that were conducted, public real-world attributed network datasets, Flickr, and ACM, were employed for performance comparison. Due to the shortage of ground truth anomalies, we follow the perturbation scheme introduced in to inject a combined set of anomalies (i.e., structural anomalies and contextual anomalies) for each dataset. The statistics of the evaluation datasets are shown in Table 1. For performance evaluation, two standard evaluation metrics (ROC-AUC and Precision@K) were used to measure the performance of different anomaly detection algorithms.

TABLE 1
Summary of attributed network datasets

| | # nodes | # edges | # attributes | # anomalies |
|---|---|---|---|---|
| BlogCatalog | 5,196 | 171,743 | 8,189 | 300 |
| Flickr | 7,575 | 239,738 | 12,047 | 450 |
| ACM | 16,484 | 71,980 | 8,337 | 600 |

Implementation Details. In the system 100, the encoder network 122 (GDN-AE) of GDN 102 is built with one 64-dimension hidden layer with ELU nonlinearity. Its output layer has a linear activation function. For the GAN 104 (Ano-GAN), the generator network 142 has one hidden layer (32-neuron) and the dimension of its output layer is 64. The discriminator network 144 had one hidden layer (32-neuron) with ReLU activation function, and employed sigmoid activation function in its last layer. The system 100 (AEGIS) was optimized with the Adam optimizer. The learning rate of the reconstruction loss was set to 0.005. The training epoch of the encoder network 122 (GDN-AE) of GDN 102 was 200, while the training epoch of the GAN 104 (Ano-GAN) is 50. In addition, the parameter K was to 3 (BlogCatalog), 2 (Flickr), 3 (ACM). Moreover, the number of samples P was set to 0.05×n for each dataset.

### Experimental Results Inductive Setting

In order to verify the effectiveness of the system 100 (AEGIS), the empirical evaluation was first conducted under the inductive setting. Three inductive models are included. Specifically, for each dataset, 50% of the nodes from the whole network were randomly sampled and extract the link relations among these nodes to construct a partially observed attributed network [symbol] . Similarly, another 40% data was sampled to construct the newly observed attributed (sub)network [symbol] ′ for testing and the remaining 10% data is for the validation purpose. After the system 100 (AEGIS) is trained on the partially observed attributed network [symbol] , we directly apply the learned model to [symbol] ′. This process was repeated 10 times and the average results are reported in FIGS. 3A-3C and Table 2.

TABLE 2
Inductive anomaly detection results on three datasets (precision varies with K)

| | Blog Catalog | | | Flickr | | | ACM | | |
|---|---|---|---|---|---|---|---|---|---|
| Methods | K = 50 | K = 100 | K = 200 | K = 50 | K = 100 | K = 200 | K = 50 | K = 100 | K = 200 |
| LOF | 0.324 | 0.212 | 0.145 | 0.366 | 0.255 | 0.190 | 0.156 | 0.128 | 0.087 |
| RCAE | 0.558 | 0.450 | 0.307 | 0.580 | 0.566 | 0.423 | 0.486 | 0.435 | 0.360 |
| GDN-AE | 0.622 | 0.505 | 0.345 | 0.640 | 0.594 | 0.452 | 0.542 | 0.467 | 0.405 |
| AEGIS | 0.704 | 0.568 | 0.382 | 0.722 | 0.661 | 0.485 | 0.626 | 0.533 | 0.432 |

To summarize, the following observations were made:

Under the inductive setting, the system 100 (AEGIS) achieves superior anomaly detection performance over other baseline methods, which demonstrates its capability for detecting anomalies on newly added data without retraining from scratch.

The performance of LOF and RCAE largely fell behind in the experiments that were conducted since they merely consider the nodal attributes for measuring node abnormality.

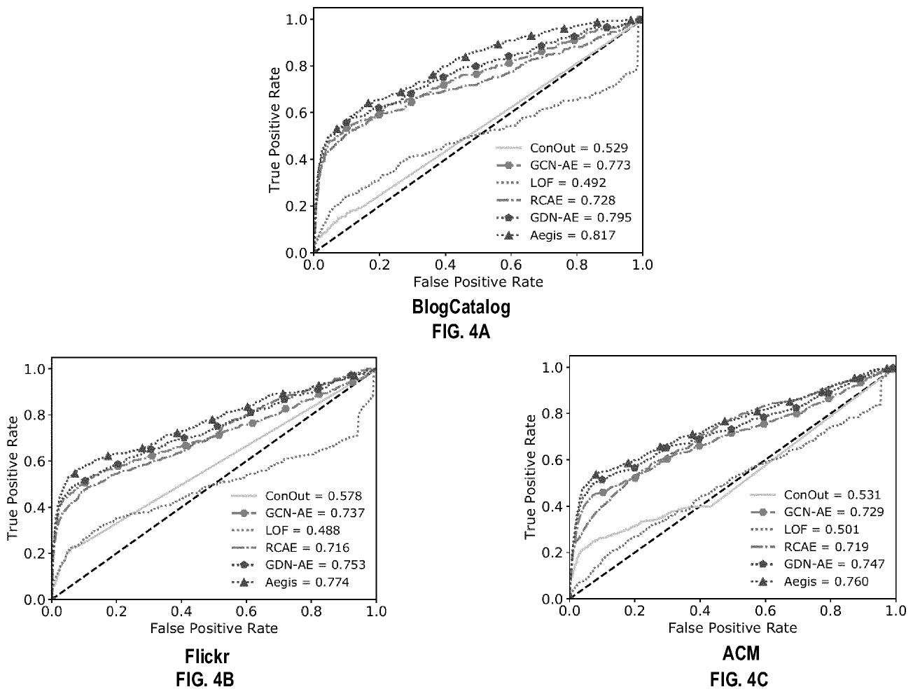

Transductive Setting. Next, the effectiveness of the system 100 (AEGIS) was evaluated under the transductive setting. Specifically, each dataset is used as a single fixed network, and each method directly performs anomaly detection on it. The results are presented in FIGS. 4A-4C and Table 3 (averaged over 10 runs).

TABLE 3
Transductive anomaly detection results on three datasets (precision varies with K)

| | Blog Catalog | | | Flickr | | | ACM | | |
|---|---|---|---|---|---|---|---|---|---|
| Methods | K = 50 | K = 100 | K = 200 | K = 50 | K = 100 | K = 200 | K = 50 | K = 100 | K = 200 |
| ConOut | 0.380 | 0.200 | 0.130 | 0.440 | 0.280 | 0.255 | 0.540 | 0.470 | 0.310 |
| GCN-AE | 0.758 | 0.712 | 0.593 | 0.756 | 0.727 | 0.685 | 0.620 | 0.589 | 0.534 |
| LOF | 0.300 | 0.220 | 0.180 | 0.0.420 | 0.380 | 0.270 | 0.180 | 0.130 | 0.115 |
| RCAE | 0.624 | 0.610 | 0.526 | 0.666 | 0.685 | 0.653 | 0.460 | 0.460 | 0.450 |
| GDN-AE | 0.772 | 0.723 | 0.622 | 0.776 | 0.742 | 0.699 | 0.632 | 0.601 | 0.542 |
| AEGIS | 0.778 | 0.730 | 0.638 | 0.784 | 0.757 | 0.705 | 0.640 | 0.606 | 0.545 |

Based on the results, the following observations were made:

The system 100 (AEGIS) outperformed all the baseline methods on all the three attributed networks. It implies that even though the system 100 (AEGIS) is mainly developed for inductive anomaly detection on attributed networks, it can also achieve competitive performance in the transductive setting.

The encoder network 122 (GDN-AE) of GDN 102 used in the system 100 (AEGIS) obtains better performance than the state-of-the-art baseline GCN-AE, which demonstrates the effectiveness of the inventive graph differentiative layer of the system 100. It verifies the advantage of the encoder network 122 (GDN-AE) of GDN 102 of the system 100 (AEGIS) for learning anomaly-aware node representations from arbitrary-order neighbors.

### Further Analysis

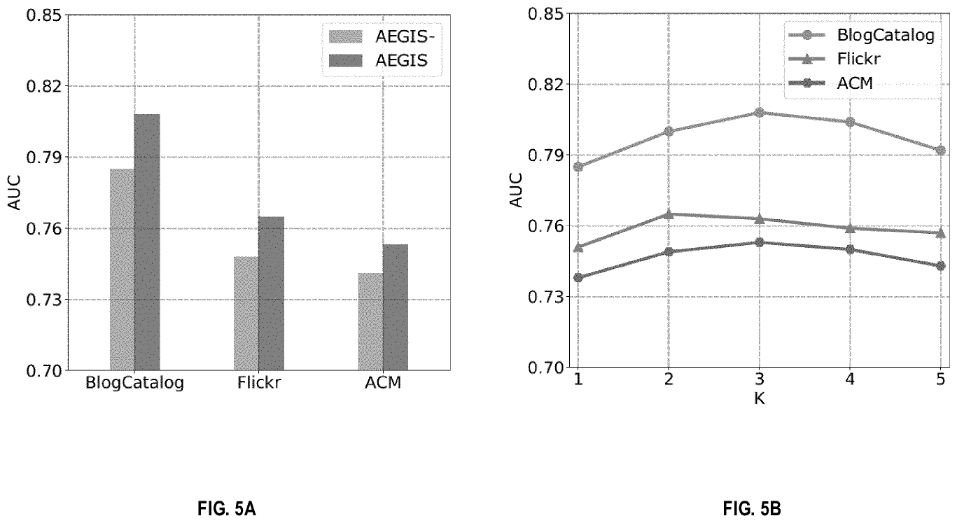

Effect of Node-level Attention. The effect of node-level attention was first studied by replacing it with the known vanilla graph attention mechanism. As shown in FIG. 5A, the system 100 (AEGIS) outperformed this variant by a noticeable margin on three datasets. It verified that the node-level attention enabled the model to learn anomaly-aware node representations by highlighting the feature difference between a node and its neighbors'.

Effect of Neighborhood-level Attention. The significance of neighborhood-level attention, which is controlled by the parameter K, can be further analyzed. AUC scores over different choices of K are reported in FIG. 5B. For the datasets considered here, the best results were obtained when K is set to 2 or 3. This confirmed that using high-order neighborhoods provided richer context information for learning anomaly-aware node representations. However, overfitting could become an issue if K is too large.

### Methods

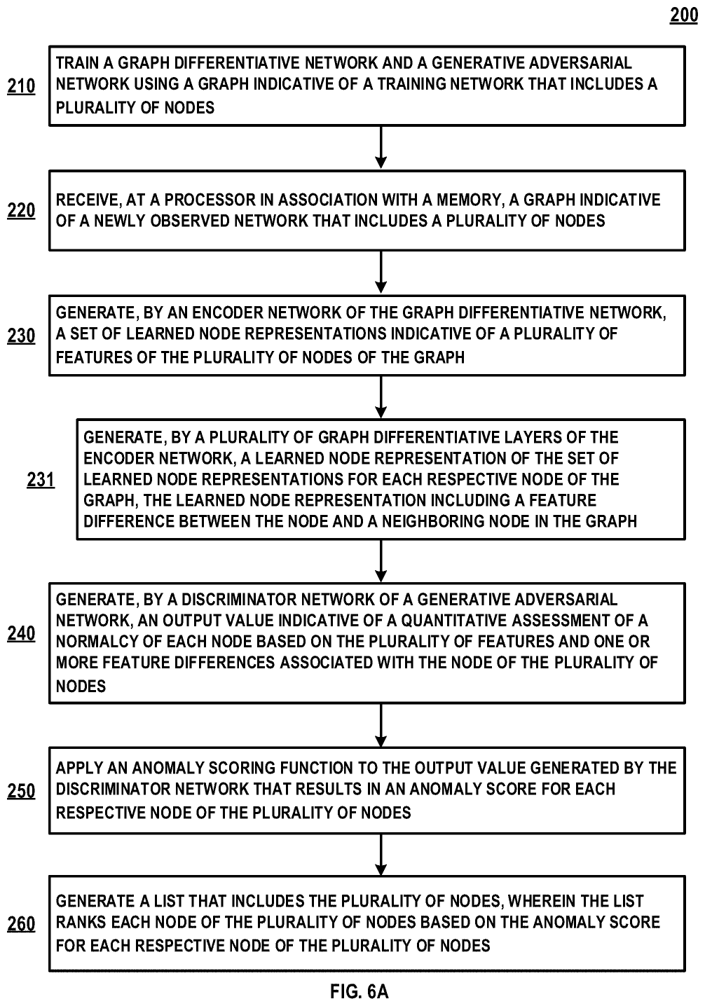

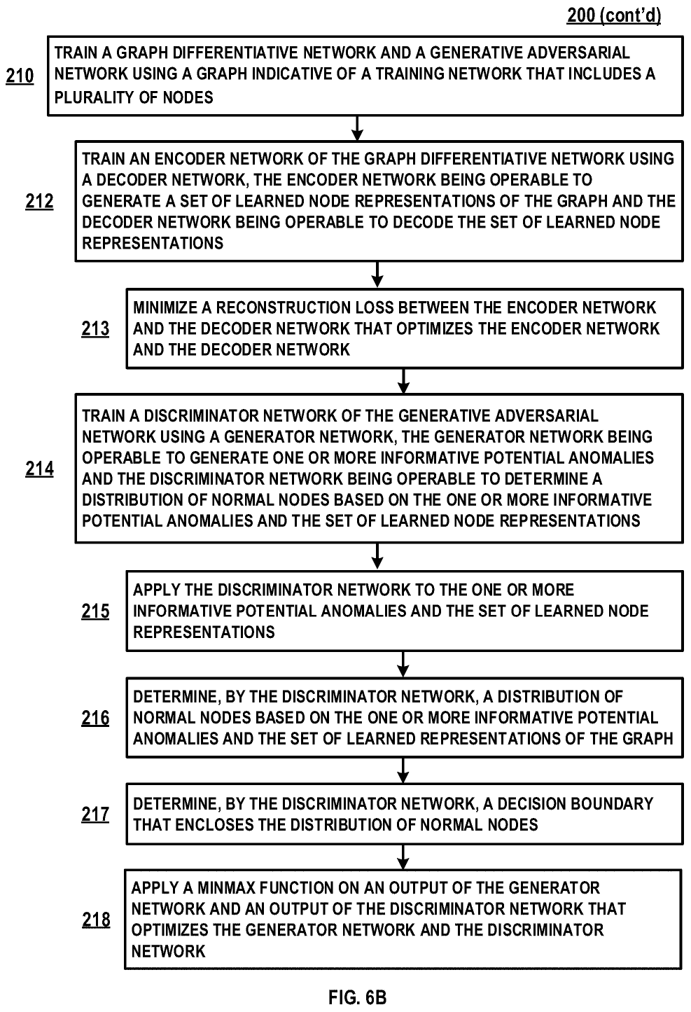

FIGS. 6A and 6B illustrate a method 200 for evaluating and detecting anomalies within a network by the system 100 of FIGS. 1A-1D. In particular, FIG. 6A provides an overall view of method 200 and FIG. 6B provides a view of a training sub-process of the method 200.

With reference to FIG. 6A, at block 210 of method 200, the system 100 trains a graph differentiative network and a generative adversarial network using a graph indicative of a training network that includes a plurality of nodes. At block 220 of method 200, the system 100 receives, at a processor in association with a memory, a graph indicative of a newly observed network that includes a plurality of nodes. At block 230 of method 200, the system 100 generates, by an encoder network of the graph differentiative network, a set of learned node representations indicative of a plurality of features of the plurality of nodes of the graph. At block 231, which is a sub-block of block 230, the system 100 generates, by a plurality of graph differentiative layers of the encoder network, a learned node representation of the set of learned node representations for each respective node of the graph, the learned node representation including a feature difference between the node and a neighboring node in the graph. At block 240 of method 200, the system 100 generates, by a discriminator network of a generative adversarial network, an output value indicative of a quantitative assessment of a normalcy of each node based on the plurality of features and one or more feature differences associated with the node of the plurality of nodes. At block 250 of method 200, the system 100 applies an anomaly scoring function to the output value generated by the discriminator network that results in an anomaly score for each respective node of the plurality of nodes. At block 260 of method 200, the system 100 generates a list that includes the plurality of nodes, wherein the list ranks each node of the plurality of nodes based on the anomaly score for each respective node of the plurality of nodes.

FIG. 6B provides various sub-blocks of block 210 of method 200 directed to training the system 100. At block 212, which is a sub-block of block 210, the system 100 trains an encoder network of the graph differentiative network using a decoder network, the encoder network being operable to generate a set of learned node representations of the graph and the decoder network being operable to decode the set of learned node representations. At block 213, which is a sub-block of block 212, the system 100 minimizes a reconstruction loss between the encoder network and the decoder network that optimizes the encoder network and the decoder network. At block 214, which is a sub-block of block 210, the system 100 trains a discriminator network of the generative adversarial network using a generator network, the generator network being operable to generate one or more informative potential anomalies and the discriminator network being operable to determine a distribution of normal nodes based on the one or more informative potential anomalies and the set of learned node representations. At block 215, which is a sub-block of block 214, the system 100 applies the discriminator network to the one or more informative potential anomalies and the set of learned node representations. At block 216, which is a sub-block of block 214, the system 100 determines, by the discriminator network, a distribution of normal nodes based on the one or more informative potential anomalies and the set of learned representations of the graph. At block 217, which is a sub-block of block 214, the system 100 determines, by the discriminator network, a decision boundary that encloses the distribution of normal nodes. At block 218, which is a sub-block of block 214, the system 100 applies a minmax function (Eq. 5) on an output of the generator network and an output of the discriminator network that optimizes the generator network and the discriminator network. In some embodiments, the minmax function in Eq. 5 can also be applied in the form of two loss functions (Eqs. 7 and 8). As such, to apply the step of block 218, the system 100 can minimize a first loss (Eq. 7) that optimizes the generator network on an output of the generator network and an output of the discriminator network and can further minimize a second loss (Eq. 8) that optimizes the discriminator network on the output of the generator network and the output of the discriminator network, the second loss incorporating the first loss such that a result of the second loss increases when a result of the first loss decreases. Further, in some embodiments, the system 100 can jointly optimize the first loss and the second loss. As such, the system 100 can implement the minmax function described in Eq. 5 through joint optimization of the first and second losses of Eqs. 7 and 8, in which the generator network and the discriminator network “compete” against one another to minimize their own respective losses and improve their performances on their respective tasks.

### Computer-Implemented System

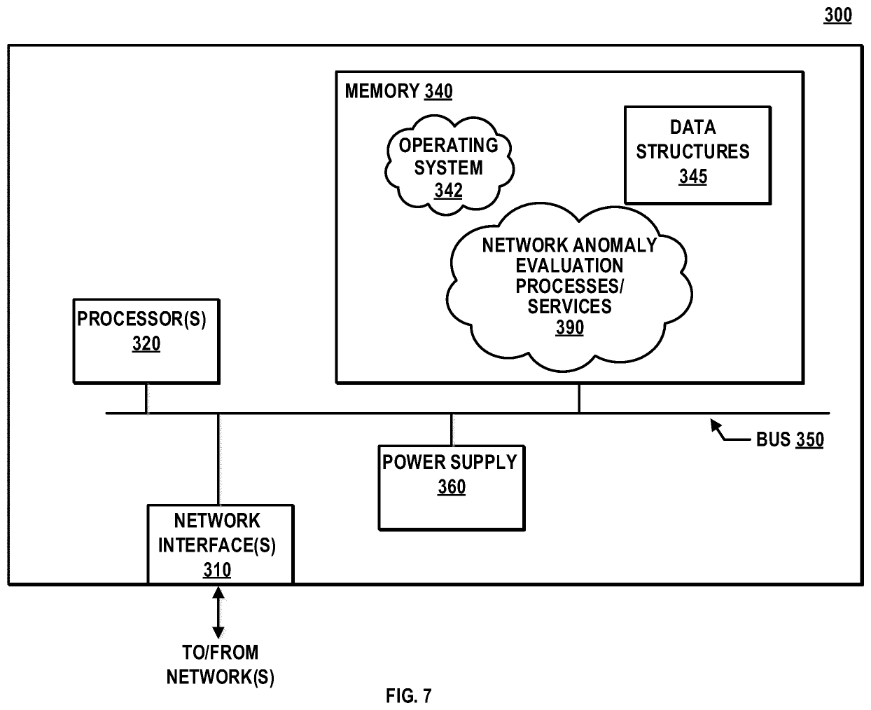

FIG. 7 is a schematic block diagram of an example device 300 that may be used with one or more embodiments described herein, e.g., as a component of system 100 shown in FIGS. 1A-1D.

Device 300 comprises one or more network interfaces 310 (e.g., wired, wireless, PLC, etc.), at least one processor 320, and a memory 340 interconnected by a system bus 350, as well as a power supply 360 (e.g., battery, plug-in, etc.).

Network interface(s) 310 include the mechanical, electrical, and signaling circuitry for communicating data over the communication links coupled to a communication network. Network interfaces 310 are configured to transmit and/or receive data using a variety of different communication protocols. As illustrated, the box representing network interfaces 310 is shown for simplicity, and it is appreciated that such interfaces may represent different types of network connections such as wireless and wired (physical) connections. Network interfaces 310 are shown separately from power supply 360, however it is appreciated that the interfaces that support PLC protocols may communicate through power supply 360 and/or may be an integral component coupled to power supply 360.

Memory 340 includes a plurality of storage locations that are addressable by processor 320 and network interfaces 310 for storing software programs and data structures associated with the embodiments described herein. In some embodiments, device 300 may have limited memory or no memory (e.g., no memory for storage other than for programs/processes operating on the device and associated caches).

Processor 320 comprises hardware elements or logic adapted to execute the software programs (e.g., instructions) and manipulate data structures 345. An operating system 342, portions of which are typically resident in memory 340 and executed by the processor, functionally organizes device 300 by, inter alia, invoking operations in support of software processes and/or services executing on the device. These software processes and/or services may include network anomaly detection processes/services 390 described herein, which can include aspects of method 200 shown in FIGS. 6A and 6B and system 100 shown in FIGS. 1A-1D. Note that while network anomaly detection processes/services 390 is illustrated in centralized memory 340, alternative embodiments provide for the process to be operated within the network interfaces 310, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the network anomaly detection processes/services 390 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

1. A system, comprising:
a processor in communication with a memory, the memory including instructions, which, when executed, cause the processor to:
receive, at the processor, a graph indicative of a network that includes a plurality of nodes;
generate, by an encoder network of a graph differentiative network in association with the processor, a set of learned node representations indicative of a plurality of features of the plurality of nodes of the graph, the encoder network being a neural network that includes a plurality of attentional weights that capture one or more feature differences between a node and one or more neighboring nodes of the plurality of nodes; and
generate, by a discriminator network of a generative adversarial network in association with the processor, an output value indicative of a quantitative assessment of a normalcy of the node of the plurality of nodes based on the plurality of features and the one or more feature differences associated with the node of the plurality of nodes, the discriminator network being a neural network.

2. The system of claim 1, wherein the memory further includes instructions, which, when executed, cause the processor to:
apply an anomaly scoring function to the output value generated by the discriminator network that results in an anomaly score for each respective node of the plurality of nodes.

3. The system of claim 2, wherein the memory further includes instructions, which, when executed, cause the processor to:
generate a list that includes the plurality of nodes, wherein the list ranks each node of the plurality of nodes based on the anomaly score for each respective node of the plurality of nodes.

4. The system of claim 1, wherein the encoder network includes a plurality of graph differentiative layers.

5. The system of claim 4, wherein the memory further includes instructions, which, when executed, cause the processor to:
generate, at each graph differentiative layer of the plurality of graph differentiative layers, a learned node representation of the set of learned node representations for each respective node of the graph, the learned node representation for a node of the plurality of nodes of the graph including a feature difference between the node and a neighboring node of the plurality of nodes in the graph.

6. The system of claim 1, wherein the graph is indicative of a newly observed network.

7. The system of claim 1, wherein the memory further includes instructions, which, when executed, cause the processor to:
train the encoder network of the graph differentiative network using a decoder network of the graph differentiative network, the decoder network being a neural network and operable to decode the set of learned node representations and the graph being indicative of a training network.

8. The system of claim 1, wherein the memory further includes instructions, which, when executed, cause the processor to:
train the discriminator network of the generative adversarial network using a generator network of the generative adversarial network, the generator network being a neural network and operable to generate one or more informative potential anomalies and the graph being indicative of a training network.

9. The system of claim 8, wherein the memory further includes instructions, which, when executed, cause the processor to:
apply the discriminator network to the one or more informative potential anomalies and one or more learned node representations of the set of learned node representations of the graph;
determine, by the discriminator network, a distribution of normal nodes based on the one or more informative potential anomalies and the set of learned representations of the graph; and
determine, by the discriminator network, a decision boundary that encloses the distribution of normal nodes.

10. A system, comprising:
a processor in communication with a memory, the memory including instructions, which, when executed, cause the processor to:
receive, at the processor, a graph indicative of a training network that includes a plurality of nodes;
train an encoder network of a graph differentiative network using a decoder network of the graph differentiative network, the encoder network and the decoder network each being a respective neural network in association with the processor, the encoder network being operable to generate a set of learned node representations of the graph and the decoder network being operable to decode the set of learned node representations; and
train a discriminator network of a generative adversarial network using a generator network of the generative adversarial network, the discriminator network and the generator network each being a respective neural network in association with the processor, the generator network being operable to generate one or more informative potential anomalies and the discriminator network being operable to determine a distribution of normal nodes based on the one or more informative potential anomalies and the set of learned node representations of the graph.

11. The system of claim 10, wherein the memory further includes instructions, which, when executed, cause the processor to:
determine, by the discriminator network, a decision boundary that encloses the distribution of normal nodes.

12. The system of claim 10, wherein the memory further includes instructions, which, when executed, cause the processor to:
minimize a first loss that optimizes the generator network on an output of the generator network and an output of the discriminator network; and
minimize a second loss that optimizes the discriminator network on the output of the generator network and the output of the discriminator network, the second loss incorporating the first loss such that a result of the second loss increases when a result of the first loss decreases.

13. The system of claim 12, wherein the memory further includes instructions, which, when executed, cause the processor to:
jointly optimize the first loss and the second loss.

14. The system of claim 10, wherein the memory further includes instructions, which, when executed, cause the processor to:
sample, by the generator network, a prior distribution value from a prior distribution; and
generate, by the generator network and using the prior distribution value, the one or more informative potential anomalies.

15. The system of claim 10, wherein the memory further includes instructions, which, when executed, cause the processor to:
minimize a reconstruction loss between the encoder network and the decoder network.

16. The system of claim 10, wherein the memory further includes instructions, which, when executed, cause the processor to:
receive, at the processor, a graph indicative of a newly observed network that includes a plurality of nodes;
generate, by the encoder network, a set of learned node representations indicative of a plurality of features of the plurality of nodes of the graph indicative of the newly observed network, the encoder network including a plurality of attentional weights that capture one or more feature differences between a node and one or more neighboring nodes of the plurality of nodes; and
generate, by the discriminator network, an output value indicative of a quantitative assessment of a normalcy of the node of the plurality of nodes based on the plurality of features and the one or more feature differences associated with the node of the plurality of nodes.

17. A method, comprising:
receiving, at a processor in association with a memory, a graph indicative of a network that includes a plurality of nodes;
generating, by an encoder network of a graph differentiative network in association with the processor, a set of learned node representations indicative of a plurality of features of the plurality of nodes of the graph, the encoder network being a neural network that includes a plurality of attentional weights that capture one or more feature differences between a node and one or more neighboring nodes of the plurality of nodes; and
generating, by a discriminator network of a generative adversarial network in association with the processor, an output value indicative of a quantitative assessment of a normalcy of the node of the plurality of nodes based on the plurality of features and the one or more feature differences associated with the node of the plurality of nodes, the discriminator network being a neural network.

18. The method of claim 17, further comprising:
applying, by the processor, an anomaly scoring function to the output value generated by the discriminator network that results in an anomaly score for each respective node of the plurality of nodes.

19. The method of claim 17, further comprising:
generating, at a graph differentiative layer of a plurality of graph differentiative layers of the encoder network, a learned node representation of the set of learned node representations for each respective node of the graph, the learned node representation for a node of the plurality of nodes of the graph including a feature difference between the node and a neighboring node of the plurality of nodes in the graph.

20. The method of claim 17, wherein the graph is indicative of a newly observed network.

21. The method of claim 17, further comprising:
training, by the processor, the graph differentiative network and the generative adversarial network, wherein the graph is indicative of a training network.

22. The method of claim 21, further comprising:
training the encoder network of the graph differentiative network by the processor and using a decoder network of the graph differentiative network, the decoder network being a neural network and operable to decode the set of learned node representations.

23. The method of claim 21, further comprising:
training the discriminator network of the generative adversarial network by the processor and using a generator network of the generative adversarial network, the generator network being a neural network and operable to generate one or more informative potential anomalies.

24. The method of claim 23, further comprising:
applying, by the processor, the discriminator network to the one or more informative potential anomalies and one or more learned node representations of the set of learned node representations of the graph;
determining, by the discriminator network in communication with the processor, a distribution of normal nodes based on the one or more informative potential anomalies and the set of learned representations of the graph; and
determining, by the discriminator network in communication with the processor, a decision boundary that encloses the distribution of normal nodes.
